(19) United States
(12) Patent Application Publication
(10) Pub. No.: US 2009/0250297 A1
(43) Pub. Date: Oct. 8, 2009

(54) Vehicle lifting and/or stabilising device, relative system and process

(76) Inventor: Giancarlo Brun, Thiene (IT)

Correspondence Address: BIRCH STEWART KOLASCH & BIRCH, PO BOX 747, FALLS CHURCH, VA, 22040-0747, US

(21) Appl. No.: 11/990,697

(22) PCT Filed: Aug. 14, 2006
(86) PCT No.: PCT/IB2006/002239

§ 371 Date: Feb. 20, 2008

(30) Foreign Application Priority Data
Aug. 22, 2005 (IT) VI2005A000233

(51) Int. Cl. B60S 9/14; B60S 9/08

(52) U.S. Cl. 187/291; 187/207

(57) ABSTRACT

The invention provides for a lifting and/or stabilising device (1, 100, 200) for vehicles in general, comprising: a fixing element (2) for anchoring the device to the vehicle; lifting means (3) provided with an actuator (6) suitable for moving a supporting element (5) along a lifting axis (7) to lift the vehicle; articulation means (4) suitable for allowing the lifting means (3) to move from one first folded position, in which the lifting axis (7) is not square to the ground (S), to a second work position in which the lifting axis (7) is in a position substantially square to the ground (S). The device (1, 100, 200) furthermore comprises connection means (8) suitable for rigidly connecting the lifting means (3) to the fixing element (2) during lifting of the vehicle. The invention furthermore concerns a relative vehicle lifting and/or stabilising system and process.

The invention concerns a vehicle lifting and/or stabilising device, particularly suitable for installation on motor vehicles, motor caravans and trailers for the lifting and parking thereof.

As is known, some vehicles such as lorries, motor caravans, motor homes, vehicles fitted out for itinerant trading etc. are provided with lifting and stabilising devices.

Said devices are fixed to the vehicle chassis and are used to lift it from the ground during garaging or parking and discharge the weight onto the ground, at least partially, without burdening the suspension.

The suspension organs and the tyres are thus relieved, at least partially, of the load they support which tends, in the long term, to gradually reduce the effectiveness thereof.

Said devices are generally, but not necessarily, installed in pairs, at the front and rear of the vehicle and can be operated independently to permit levelling of the vehicle even on ground which is not perfectly level.

In the case of caravans or vehicles fitted out for itinerant trading, use of the above-mentioned devices increases comfort and reduces the swaying and rocking to which the vehicle is subject while it is parked due to the movement of the occupants. They furthermore allow the vehicle to be kept level, permitting better operation of the on-board equipment and the sink drains.

The known stabilisation devices substantially comprise a fixing element for anchoring the device to the vehicle chassis and lifting means provided with a retractable supporting element.

The lifting means comprise an actuator suitable for vertically lowering/raising the supporting element to move it from the work position, in contact with the ground, to a raised rest position.

The actuator generally consists of a jack controlled by a corresponding power and control unit.

To raise the vehicle, the user operates the actuator via the control unit, lowering the supporting element until the vehicle has been raised.

Vice versa, to lower the vehicle the user operates the actuator again via the control unit, retracting the supporting element and raising it until it is in the rest position.

Some devices, to reduce their overall dimensions in the retracted position, provide for the lifting means to be connected to the fixing element by articulation means which permit the folding thereof.

More precisely, said articulation means consist of a hinge which allows the jack to rotate around a horizontal axis to a position parallel to the ground, to a vertical position and resting against the fixing element.

A first drawback of the devices of known type consists in the fact that the articulation means weaken the device, limiting the transverse loads that can be withstood. This causes instability of the vehicle in its raised position. In fact it tends to sway crosswise and/or lengthways when stressed with the clear risk of falling off the lifting device.

A further drawback connected with the preceding one consists in the fact that, to prevent the vehicle falling off, it is not raised completely from the ground with obvious disadvantages.

The aim of the present invention is to overcome said drawbacks.

In particular a first object of the invention is to produce a lifting and/or stabilising device particularly suitable for installation on motorised and non-motorised vehicles, such as lorries, trailers, motor caravans, motor homes and vehicles fitted out for itinerant trading.

A further object is to produce a folding device which, with respect to the known devices, is more insensitive to transverse stress and guarantees the vehicle greater stability and equilibrium, also in the presence of said stress.

A further object is to produce a device which permits the vehicle to be raised even completely, guaranteeing the stability thereof.

A further object is to produce a folding device which can be installed simply and quickly, applicable to the chassis of any vehicle.

A further object is to produce a device that does not require housing recesses for its installation.

A further object is to produce a device that can be easily removed and fitted on another vehicle.

A further object is to produce a lifting device and system that permits rapid easy levelling of the vehicle, useful also to compensate for any irregularities in the ground.

A further object is to produce a device which, by lifting, even only partial, of the vehicle from the ground, causes immobilisation of the vehicle, thus acting as an anti-theft device.

A further object is to produce a device which, by lifting the vehicle, is able to lighten, partially or totally, the load on the tyres, preventing from becoming out-of-round during prolonged standstills.

Last but not least, a further object is to produce a lifting device and a system which is inexpensive and easy to use, in addition to being easy to construct, assemble and install, suitable also for mass production.

Said objects are achieved by a lifting and/or stabilising device, by a lifting and/or levelling system and by a process for lifting a vehicle, expressed and characterised in the respective independent claims.

Advantageous embodiments constitute the subject of the dependent claims.

The solution proposed advantageously permits the production of a lifting and/or stabilising device able to withstand greater transverse loads and stress than the known devices.

Again advantageously the device proposed has minimum overall dimensions in the rest position, at the same time guaranteeing, during use, the stability and equilibrium of the vehicle also when the wheels are raised.

Said objects and advantages will be better highlighted during the description of some preferred embodiments of the invention, provided for indicative non-limiting purposes, with reference to the attached drawings in which:

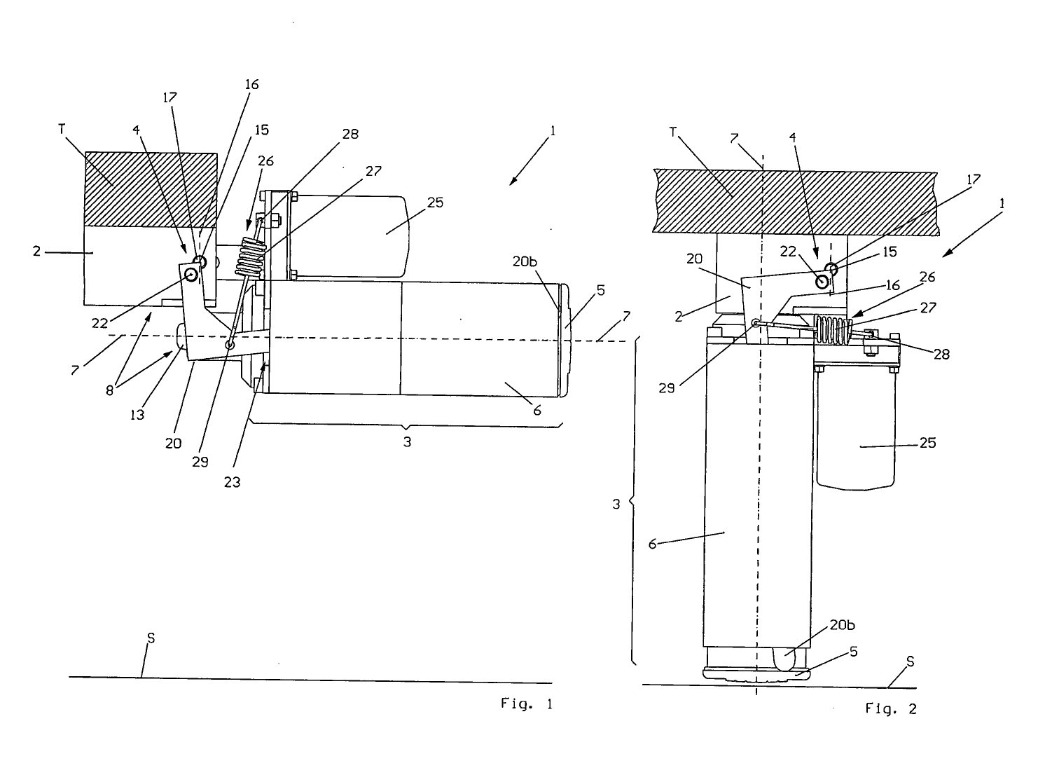

FIG. 1 shows a lateral view of a device of the invention in a rest position;

FIG. 2 shows a lateral view of the device of FIG. 1 in a different work position;

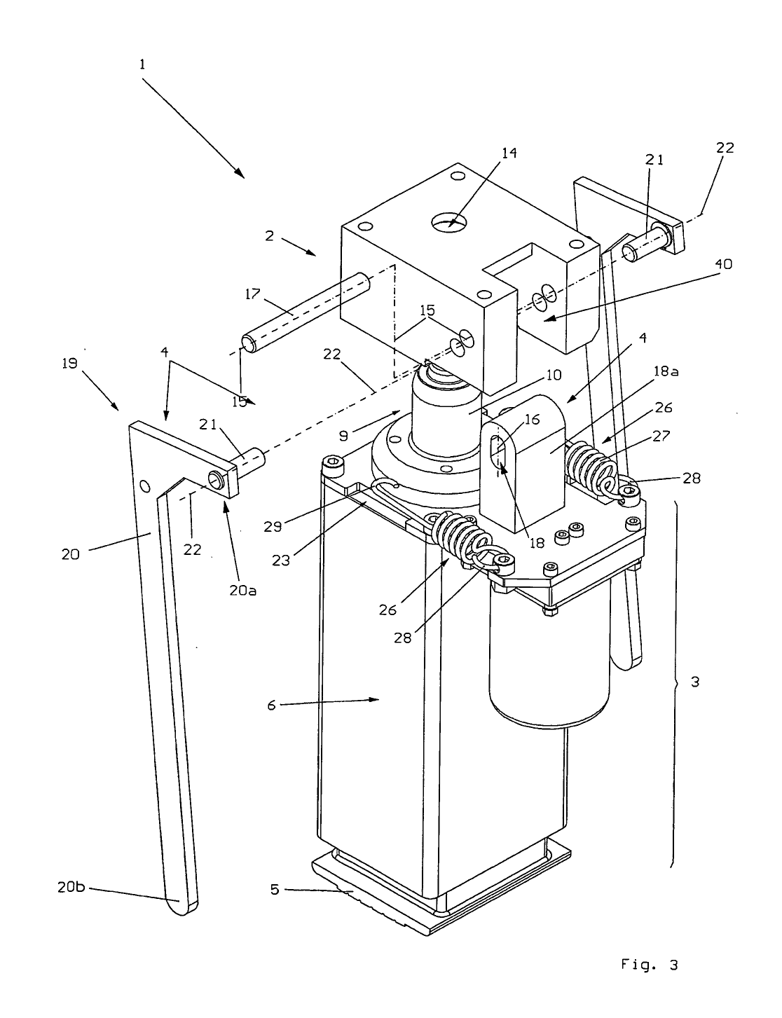

FIG. 3 shows an axonometric exploded view of the device of FIG. 1;

FIG. 4 shows an axonometric view of an element of the device of FIG. 1;

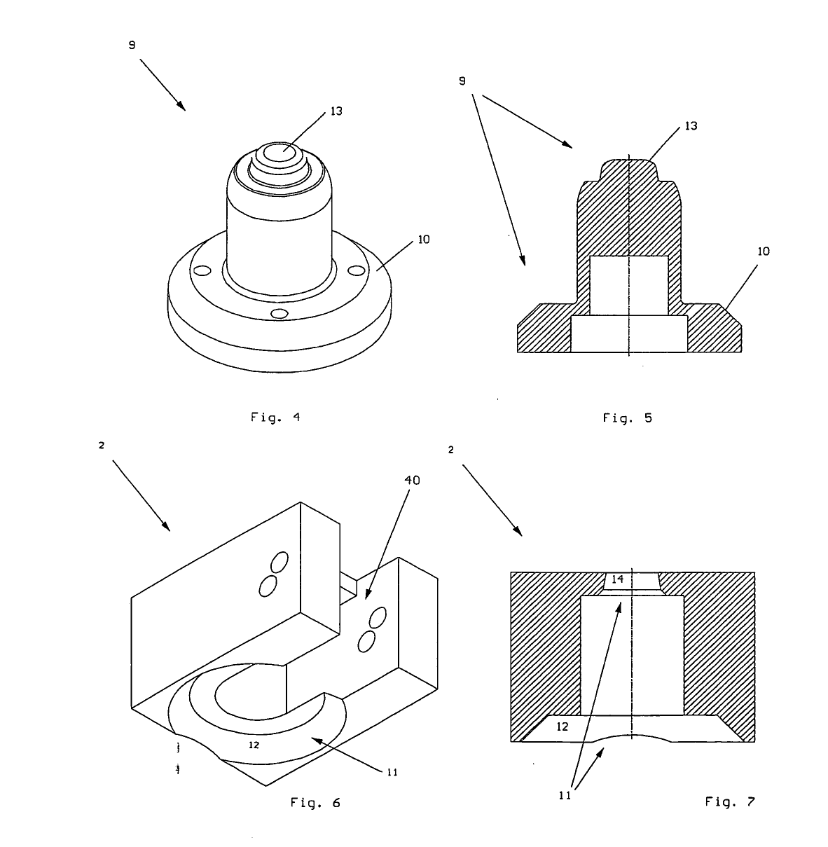

FIG. 5 shows a view of a longitudinal section of the element of FIG. 4;

FIG. 6 shows an axonometric view of another element of the device of FIG. 1;

FIG. 7 shows a view of a longitudinal section of the element of FIG. 6;

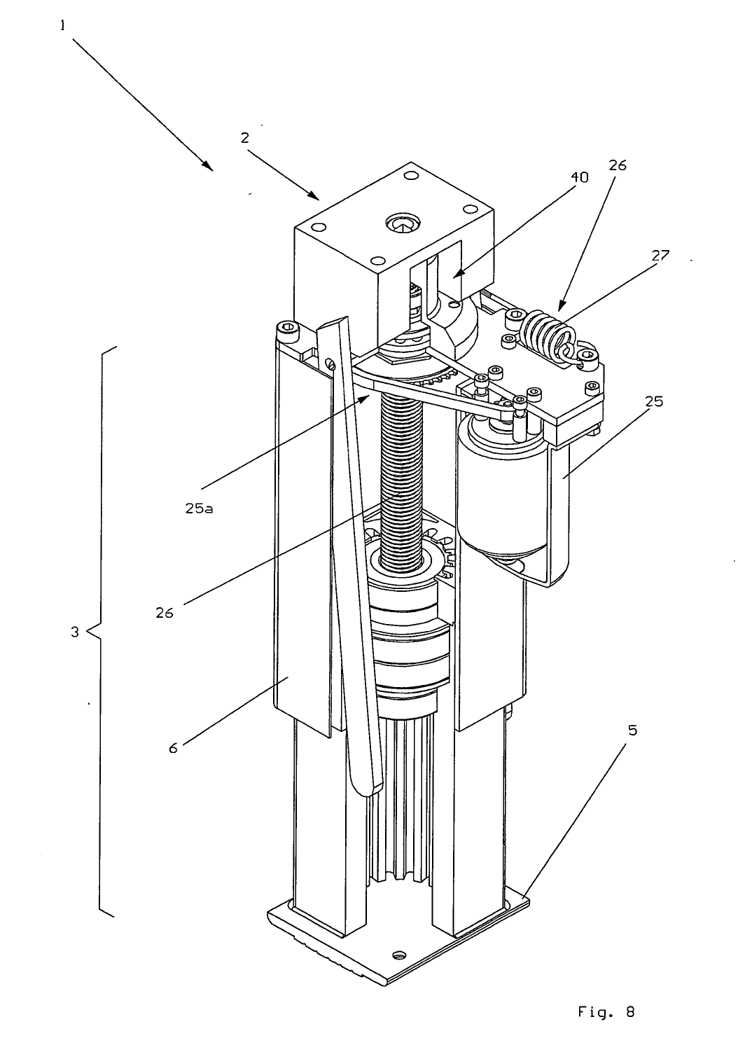

FIG. 8 shows an axonometric view of a partial longitudinal section of the device of FIG. 1;

FIG. 9 shows a lateral view of another device of the invention in a rest position;

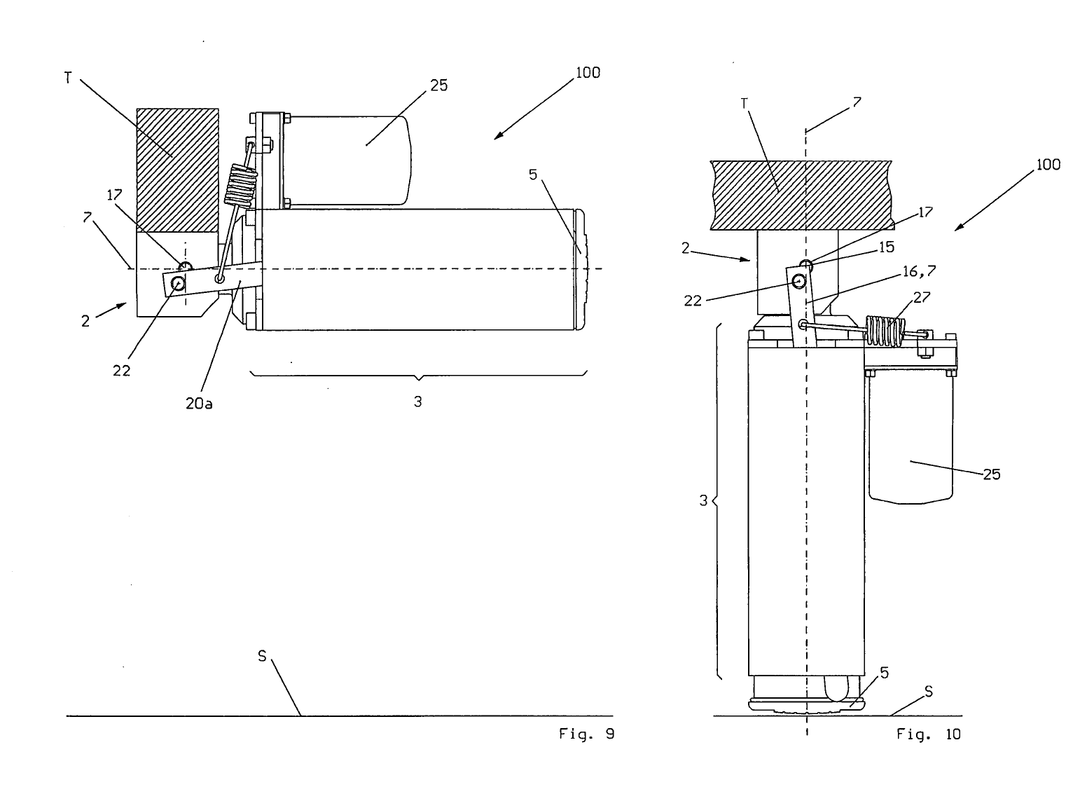

FIG. 10 shows a lateral view of the device of FIG. 9 in a different work position;

FIG. 11 shows an axonometric exploded view of the device of FIG. 9;

FIG. 12 shows an axonometric view of an element of the device of FIG. 9;

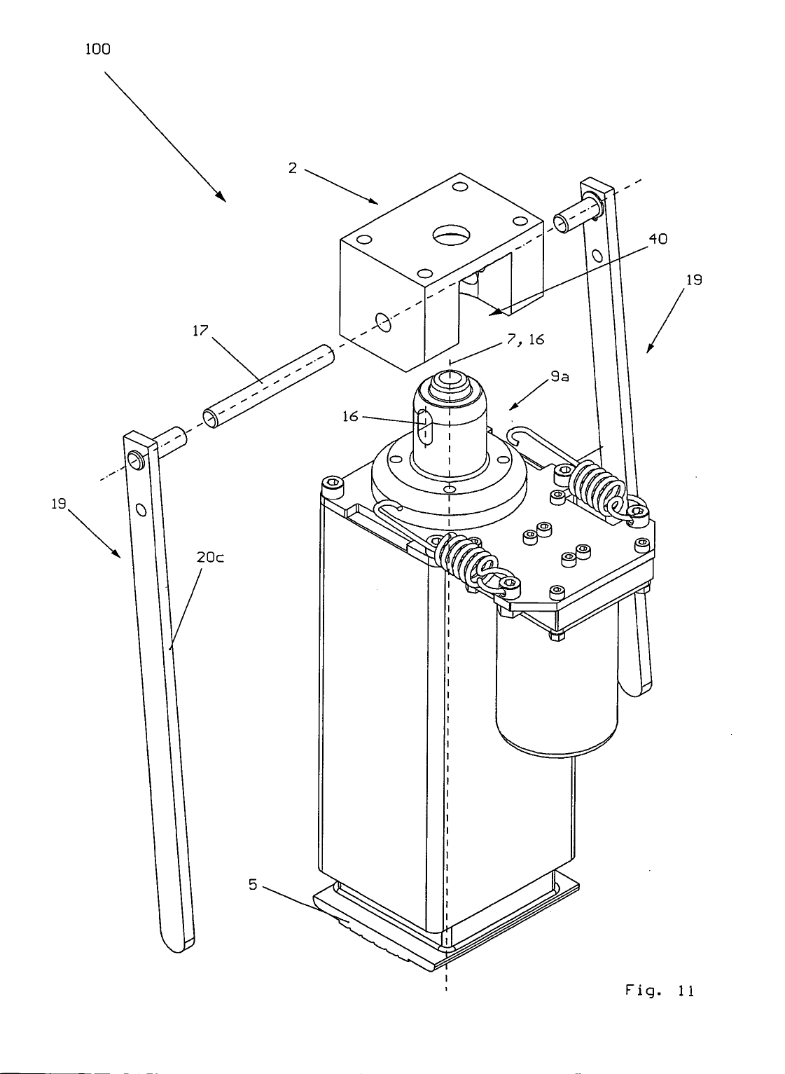

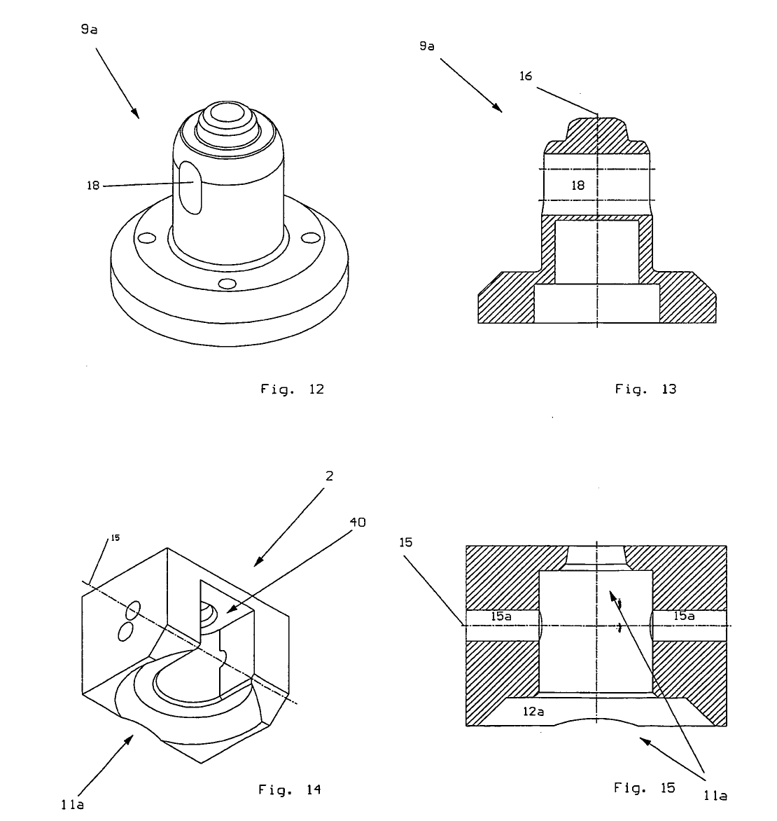

FIG. 13 shows a view of a longitudinal section of the element of FIG. 12;

FIG. 14 shows an axonometric view of another element of the device of FIG. 9;

FIG. 15 shows a view of a longitudinal section of the element of FIG. 14;

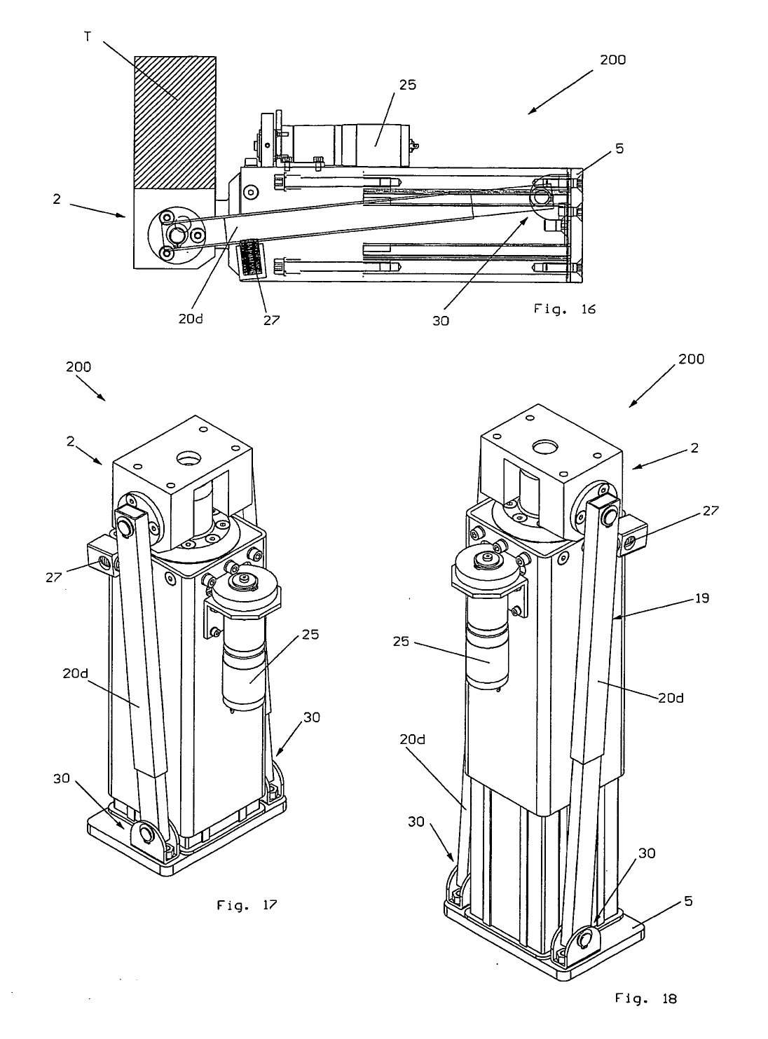

FIG. 16 shows a lateral view of a further device of the invention in a rest position;

FIG. 17 shows an axonometric view of the device of FIG. 16 in a work position;

FIG. 18 shows an axonometric view of the device of FIG. 16 in another extended work position;

FIG. 19a shows an axonometric view of an executive variation of the element of FIG. 12;

FIG. 19b shows a plan view of the element of FIG. 19a;

FIG. 19c shows an axonometric view of an executive variation of the element of FIG. 14;

FIG. 19d shows a view from below of the element of FIG. 19c;

FIG. 19e shows an axonometric view of another executive variation of the element of FIG. 12;

FIG. 19f shows a plan view of the element of FIG. 19e;

FIG. 19g shows an axonometric view of an executive variation of the element of FIG. 14;

FIG. 19h shows a view from below of the element of FIG. 19g;

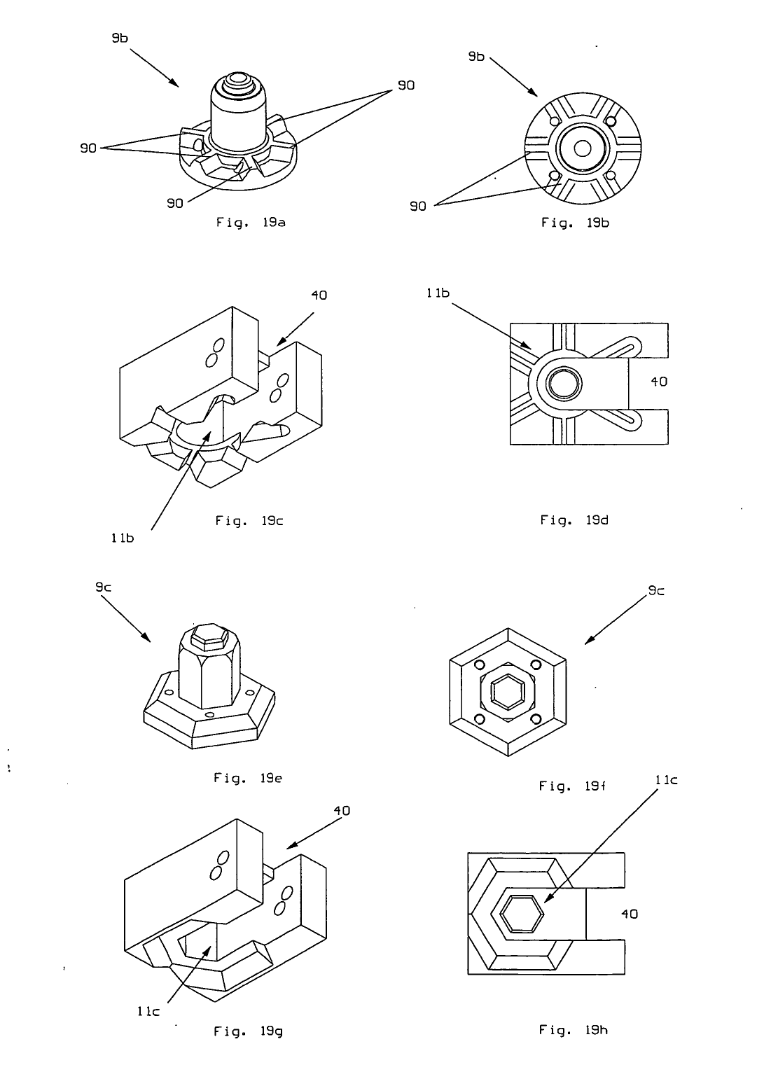

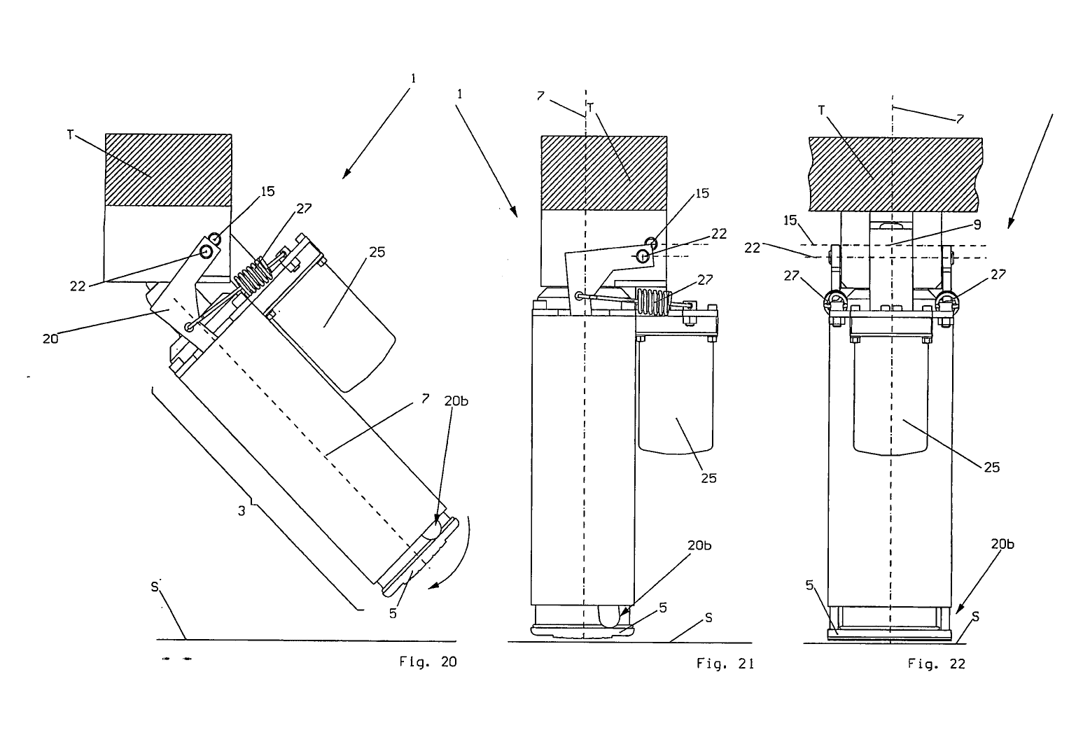

FIG. 20 shows the device of FIG. 1 in a work phase;

FIG. 21 shows a first lateral view of the device of FIG. 1 in another work position;

FIG. 22 shows a second view of the device of FIG. 1 in the same work position as shown in FIG. 21;

FIG. 23 shows a first lateral view of the device of FIG. 1 in a further work position;

FIG. 24 shows a second view of the device of FIG. 1 in the same work position as shown in FIG. 23;

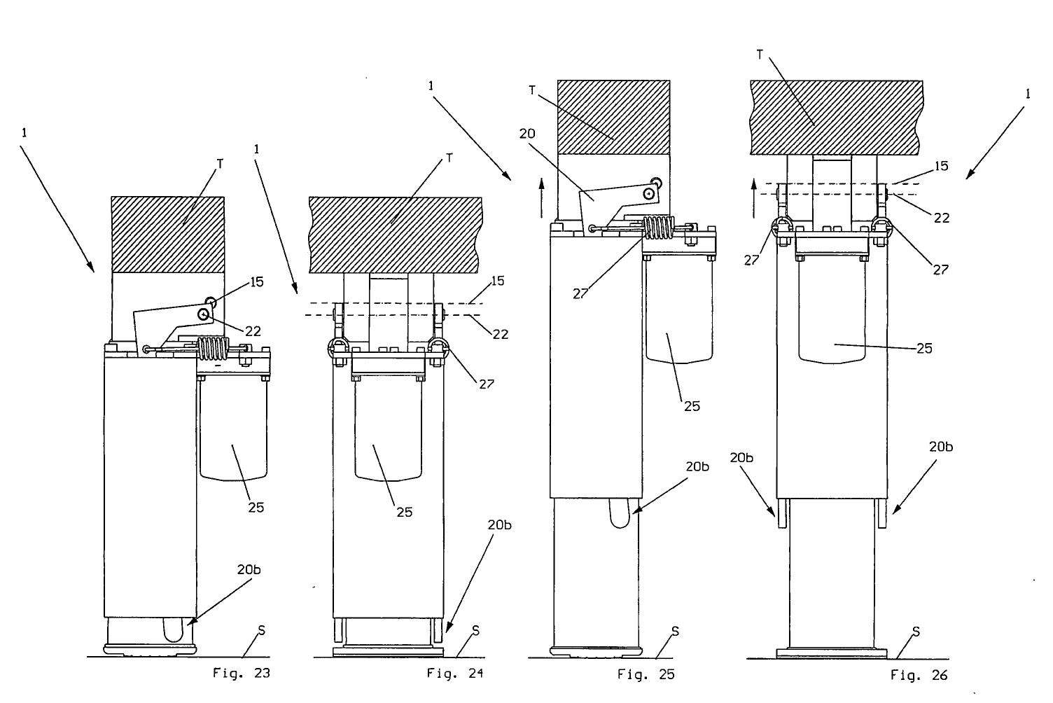

FIG. 25 shows a first lateral view of the device of FIG. 1 in another work position;

FIG. 26 shows a second view of the device of FIG. 1 in the same work position as shown in FIG. 25;

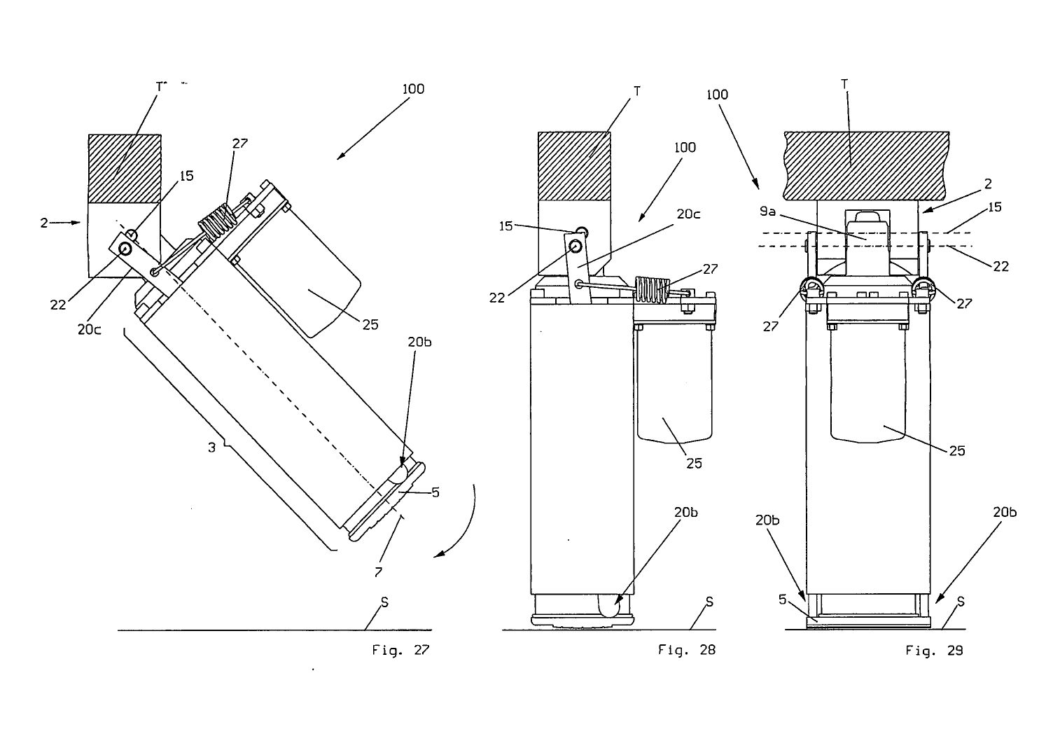

FIG. 27 shows the device of FIG. 9 in a work phase;

FIG. 28 shows a first lateral view of the device of FIG. 9 in another work position;

FIG. 29 shows a second view of the device of FIG. 9 in the same work position as shown in FIG. 28;

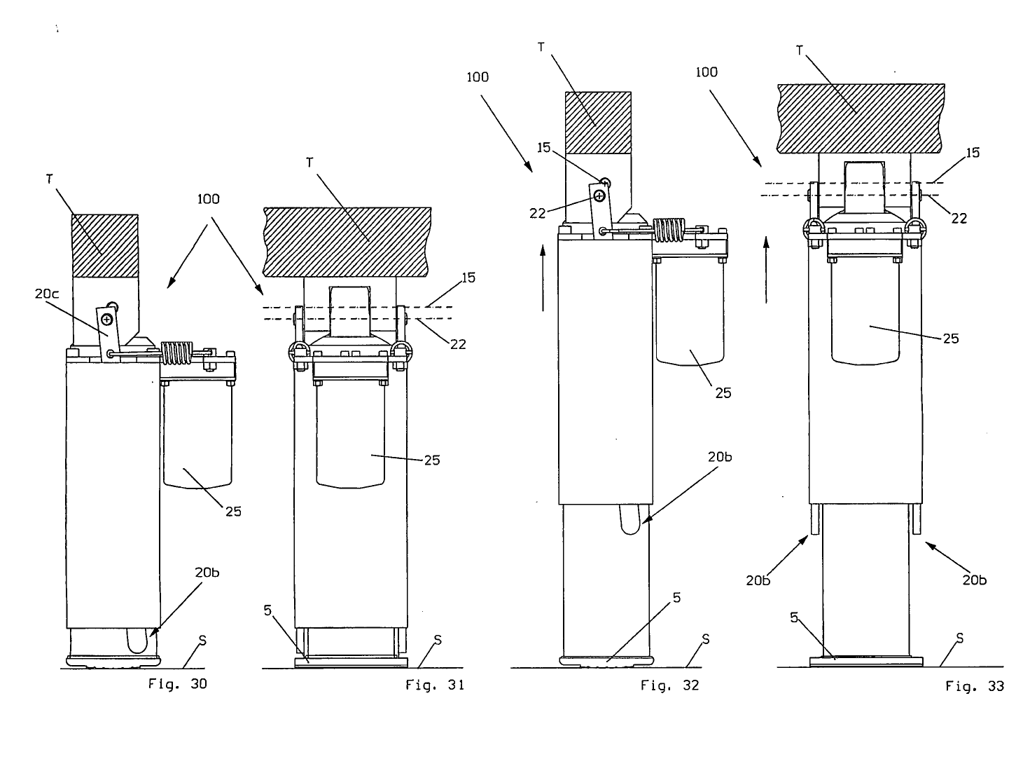

FIG. 30 shows a first lateral view of the device of FIG. 9 in a further work position;

FIG. 31 shows a second view of the device of FIG. 1 in the same work position as shown in FIG. 30;

FIG. 32 shows a first lateral view of the device of FIG. 9 in another work position;

FIG. 33 shows a second view of the device of FIG. 1 in the same work position as shown in FIG. 32;

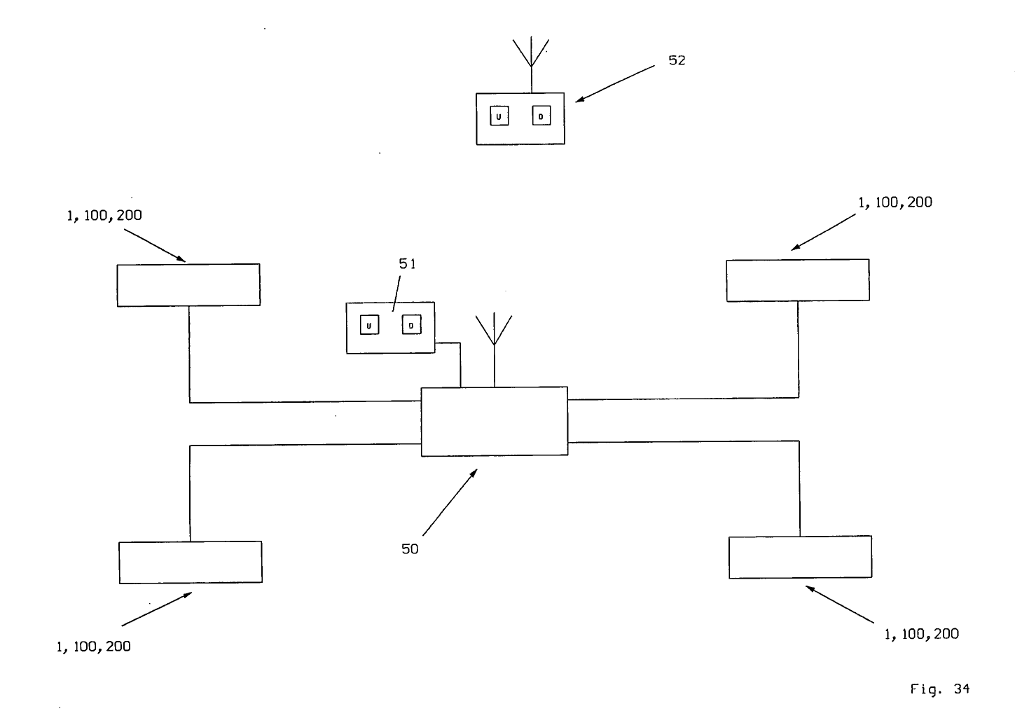

FIG. 34 shows a block diagram of a vehicle lifting/levelling system, also subject of the invention.

By way of introduction, it is highlighted that the equal parts of the individual executive examples are provided with the same reference numbers. In the case of a variation of the position of said parts, the indications mentioned in the individual executive examples must be transferred, according to sense, to the new position.

A lifting and/or stabilising device for vehicles in general, subject of the present invention, is shown in FIGS. 1 to 3, where it is indicated overall by number 1.

It comprises a fixing element 2 for anchoring the device 1 to the chassis T of a vehicle not shown and means 3 for lifting the vehicle, connected to the element 2 by articulation means, indicated overall by number 4.

The lifting means 3 are provided with a retractable supporting element 5 and comprise an actuator 6 suitable for moving said supporting element 5 along a lifting axis 7 to lift the vehicle.

The articulation means 4 are suitable for enabling the lifting means 3 to move from at least one first folded position, in which said lifting axis 7 is substantially horizontal and/or parallel to the ground S, shown in FIG. 1, to at least one second position in which the lifting axis 7 is in a position substantially vertical and/or square to the ground S, shown in FIG. 2.

According to the invention the device 1 furthermore comprises connection means, indicated overall by number 8, suitable for rigidly connecting the lifting means 3 to the fixing element 2 during lifting of the vehicle and for guaranteeing almost equal resistance to loads parallel to the ground, regardless of their direction.

In the embodiment example shown, said connection means 8 comprise a male-female type coupling, which can be seen in detail in FIGS. 3 to 7, which provides for a first connection element 9 integral with the lifting means 3 suitable for coupling with a second connection element 11 integral with the fixing element 2.

In particular the first element 9, male, comprises a truncated cone-shaped head 10, shown in detail in FIGS. 4 and 5, while the second element 11, female, comprises a corresponding truncated cone-shaped seat 12 with substantially conjugate profile, shown in FIGS. 6 and 7, provided in the fixing element 2.

It should be observed that in the embodiment shown, the male element 9 presents, furthermore, a projecting element 13 suitable for being housed in a corresponding seat 14 of the female element 11, which can be seen in FIG. 7. The tapered or cylindrical shape of the conjugate surfaces of the male element 9 and female element 11 guarantee the almost uniform resistance of the coupling to loads parallel to the ground, regardless of their direction. The two coupling areas, i.e. the truncated cone-shaped head 10 in the seat 12 and the element 13 in the seat 14, positioned at an appropriate distance, provide a resistant coupling with a limited engagement stroke.

Observe also the presence of a side aperture 40 of the female element 11 which permits coupling/decoupling of the connection means 8 using a very small fraction of the stroke of the actuator 6.

As regards the articulation means 4, they substantially comprise a joint which can be seen in FIGS. 1, 2 and 3, with at least two degrees of freedom, which allows the lifting means 3 to rotate with respect to a first axis 15 substantially horizontal and to translate along a second axis 16 substantially square or transverse to the first one to permit, as will be seen better below, coupling and decoupling of the two connection elements 9 and 11.

In the embodiment shown, the joint, which can be seen in particular in FIG. 3, is made of a pin 17 integral with the fixing element 2 which engages in a shaped through hole 18 provided in a bracket 18a integral with the lifting means 3.

The means 3 can thus rotate around the first axis 15 substantially horizontal and/or parallel to the ground S identified by the pin 17, and translate along the second axis 16 substantially square to the first axis 15.

The articulation means 4 furthermore comprise at least one guide element 19, in the case in point two, provided, in the embodiment shown, with at least one guide rod 20.

The rod presents one first end 20a hinged to a pin 21 identifying a rotation axis 22 substantially parallel to the rotation axis 15 of the lifting means 3 and the other end 20b suitable for positioning in contact with the supporting element 5, to counter the movement thereof, as will be better described below, and to permit coupling and decoupling of the connection means, and support of the lifting means 3 in the rest position.

It should be observed that the rotation axis 22 of the rod 20 and the rotation axis 15 of the lifting means 3, in the case in point, are not coaxial. This advantageously permits exploitation of the movement of the element 5 to obtain both the rotation movement of the means 3 and blocking of the articulation means 4, as will be seen better below.

It should also be observed that each rod 20 is housed in a guide hole 23, which can be seen in detail in FIG. 3, which limits and guides the movement thereof.

As regards the lifting means 3, they comprise, in the embodiment shown, a screw jack, shown in detail in FIG. 8 in a partially extended position, driven by an electric motor 25 which moves the screw 26 by means of mechanisms 25a.

The electric motor 25 is controlled by a control unit, not shown, which can be activated, according to a preferred embodiment, by means of a remote control device, for example a radiofrequency device.

The device furthermore comprises elastic means 26, which can be seen in FIGS. 1 to 3, including, in the embodiment shown, of two helical springs 27 cooperating with the articulation means 4.

More precisely, each spring 27 has an end 28 integral with the lifting means 3 and the other end 29 integral with the guide rod 20.

Said elastic means 26, although not essential, contribute, as will be seen better below, to the movement and positioning substantially square to the ground of the lifting means 3.

A further device subject of the present invention, indicated overall by number 100 in FIGS. 9 to 11, differs from the preceding one due to the fact that the through hole 18 in which the pin 17 of the articulation means 4 engages is provided on the male connection element 9a, as shown in detail in FIGS. 12 and 13. Consequently the seat 12a of the female element 11a, shown in detail in FIGS. 14 and 15, has a through hole 15a suitable for accommodating the pin 17 which engages in the hole 18. In said embodiment the lifting axis 7 and the translation axis 16 identified by the articulation means 4 coincide during the lifting phase. The device 100 furthermore differs due to the fact that the guide elements 19 consist of rectilinear rods 20c.

Said solution advantageously permits elimination of the bracket 18a thus reducing the number of components of the device, increasing its compactness and simplifying construction. Also in said case the presence of the side aperture 40 in the female element 11a has the function of permitting coupling/decoupling of the connection means 8 using a very small fraction of the stroke of the actuator 6.

A further example of embodiment of the device of the invention, indicated overall by number 200 in FIGS. 16 to 17, differs from the previous one due to the fact that the guide elements 19 comprise at least one telescopic rod 20d, in the case in point two, and that they connect the supporting element 5 to the fixing element 2.

More precisely each telescopic rod 20d is linked at the bottom to the supporting element 5 by means of a hinge 30.

Further embodiments of the invention provide for different forms of the connection means 8 and in particular of the first and second elements, male/female, 9 and 11.

By way of example FIGS. 19a to 19h show some different embodiments of said elements.

In particular FIGS. 19a and 19b show a male element, indicated overall by number 9b, provided with polygonal section teeth 90 suitable for coupling with a corresponding female element 11b shown in FIGS. 19c and 19d.

FIGS. 19e and 19f show a further male element with polygonal base, indicated overall by number 9c, in particular hexagonal, which couples with a corresponding female element 11c provided with conjugate profile seats, shown in detail in FIGS. 19g and 19h.

It is also clear that the male element can, in other embodiments not shown, be integral with the fixing element 2 and therefore the female element will be integral with the lifting means.

Operation of the device of the invention will now be described with reference to the first example of embodiment of the invention described and shown in FIGS. 1 to 3, there being no substantial differences with respect to the other embodiments described.

To raise the vehicle or a part of it, the user operates, via the control unit, the device installed on the vehicle which is arranged in the rest position shown in FIG. 1.

The control unit thus powers the electric motor 25 which drives the jack 6, extending it.

Extension of the jack 6 causes it, due to the action of the rods 20, to rotate around the axis 15, as shown in detail in FIG. 20.

Said rotation movement continues until the jack 6 is positioned with the lifting axis 7 in a position substantially square to the ground, as shown in detail in FIGS. 2, 21 and 22. Reaching of the position substantially square to the ground is guaranteed by the action of the elastic means 26, which generate a force sufficient to remove any small obstacles on the ground S and to counter the gravity if the ground and the vehicle are on a slight slope.

It should be observed that in said phase the supporting element 5 is not yet in contact with the ground S and that the male elements 9 and female elements 11 are perfectly aligned but not coupled.

Continuing its movement, the motor further extends the jack 6 causing detachment of the rods 20 from the supporting element 5 and therefore stoppage of the rotation around the axis 15.

The further rotation of the motor 25 further lowers the supporting element 5 until it meets the ground S.

At this point the jack 6, continuing to extend and meeting the obstacle of the ground S, translates vertically, causing coupling of the male/female elements 9 and 11, as shown in detail in FIGS. 23 and 24.

More precisely the pin 17 runs inside the slot 18 until the two elements 9 and 11 engage and block each other, making the connection between the lifting means 3 and the chassis T rigid.

Further operation of the device 1 causes the vehicle to be lifted from the ground S, as shown in detail in FIGS. 25 and 26.

Having reached the required height, the user deactivates the device 1 which stays in the position reached.

To lower the vehicle the user operates the remote control by pressing the corresponding button, thus starting the lowering process which involves the same phases as those previously described, performed in reverse order.

More precisely, the control unit, having received the signal, rotates the motor 25 in the direction opposite to the one assumed during the lifting phase.

The vehicle thus begins to move down until it touches the ground.

The supporting element 5 then rises from the ground S until it encounters the rods 20.

Said rods 20, preventing the element 5 from moving further up, pull the male element 9 downwards thus obtaining decoupling of the two male and female elements 9 and 11 exerting, if necessary, also a force such as to overcome accidental jamming and seizure caused by dirt, impact deformations etc.

More precisely rotation of the motor 25 causes the jack 6 to move down until the pin 17 reaches the upper end of the shaped hole 18, configuring the device as shown in FIGS. 21 and 22.

The further rotation of the motor 25 and the contrast of the element 5 with the rods 20 causes the jack 6 to rotate upwards, around the axis 15, resetting it to the initial position shown in FIG. 1.

A sensor, comprising a switch or a button not shown, detects that the rest position has been reached and automatically blocks the motor 25.

Having reached said position, the device subject to the traction force of the jack 6 and the counter action of the rods 20 remains stable in said position, ready for any new vehicle lifting operation.

It should be observed that advantageously the axis of rotation 22 of the rod 20 is positioned below the horizontal surface that intersects the rotation axis 15 of the lifting means 3 and in the semi-space formed by the vertical plane passing through the same rotation axis 15 which is not involved in rotation of the lifting means 3.

This advantageously allows the device 1 to perform the movement described, preventing the rod 20 positioning itself along the straight line joining the two rotation axes 15 and 22.

In said conditions, in fact, extension or retraction of the lifting means 3 due to operation of the motor 25 would not have any effect other than breakage of the device 1.

It should be observed that advantageously the coupling of the two elements 9 and 11 is obtained by exploiting the extension of the jack 6 and that said coupling blocks the articulation means 4 making the connection between jack and chassis T rigid.

FIGS. 28 to 33 show the device 100 in the same raising/lowering operating phases as described for device 1.

From what has been said it is clear that the process for lifting a vehicle by means of a relative lifting and/or stabilisation device 1, 100, 200, according to the invention, provides, before the vehicle is lifted, for the lifting means to be connected rigidly to the fixing element, exploiting their movement, via a male-female coupling.

FIG. 34 shows a lifting, stabilisation and levelling system comprising a control unit 50 which controls four devices 1, 100, 200 produced according to the invention.

In the case in point the control unit 50 comprises an apparatus, also called electronic spirit level, cooperating with a processing unit that drives the various devices.

The electronic spirit level is able to perceive any slanting of the vehicle in its two longitudinal and transverse axes and transit said information to the processing unit which adjusts the various lifting devices until the vehicle is levelled.

In the case in point the control unit 50 is furthermore provided with a control panel 51 for local activation and a radio receiver unit cooperating with a corresponding radio transmission unit 52, for remote activation of the device.

It should be observed that the energy required for operation of both the control unit and the actuator can advantageously be supplied by the vehicle electrical system and/or by additional accumulators and/or generators.

It is clear that, in other embodiments, the lifting means 3 can also be activated manually for example by means of a crank which, as it rotates, moves the worm screw via the mechanisms.

Again advantageously the actuator 6 can comprise, in other embodiments, a hydraulic or pneumatic jack or equivalent systems.

Experimental tests have shown that the device proposed, by blocking the articulation means before lifting the vehicle simply and automatically, guarantees greater insensitivity to the transverse stress to which the vehicle is subject when in the raised position.

Again advantageously it should be observed that the solution proposed allows part of the stroke of the jack to be used to obtain both automatic positioning of the device in the various work and rest positions and locking/release of the articulation means.

From what has been said it is clear that the solution proposed permits solving of said drawbacks and achievement of the set objectives.

Although the invention has been described with reference to the attached drawings, modifications can be made in the production phase, all falling within the same inventive concept expressed by the claims below and therefore protected by the present patent.

1-35. (canceled)

36. Lifting and/or stabilising device (1, 100, 200) for vehicles in general, comprising:
at least one fixing element (2) for anchoring said device to said vehicle;
lifting means (3) provided with an actuator (6) suitable for moving at least one supporting element (5) along a lifting axis (7) to lift said vehicle;
articulation means (4) suitable for allowing said lifting means (3) to move from at least one first folded position, in which said lifting axis (7) is not square to the ground (S), to at least one second work position in which said lifting axis (7) is in a position substantially square to the ground (S);
connection means (8) suitable for rigidly connecting said lifting means (3) to said fixing element (2) during lifting of said vehicle and comprising a male-female type coupling with a first connection element (9, 9a, 9b, 9c) and a second connection element (11, 11a, 11b, 11c) said first connection element (9, 9a, 9b, 9c) being suitable for coupling with said second connection element (11, 11a, 11b, 11c);
wherein said first element (9, 9a, 9b, 9c) comprises a truncated cone-shaped head (10) and said second element (11, 11a, 11b, 11c) comprises a corresponding truncated cone-shaped seat (12, 12c) with substantially conjugate profile.

37. Device according to claim 36, wherein said first connection element (9, 9a, 9b, 9c) is integral with said lifting means (3) and wherein said second connection element (11, 11a, 11b, 11c) is integral with said at least one fixing element (2).

38. Device according to claim 36, wherein said first connection element (9, 9a, 9b, 9c) is integral with said at least one fixing element (2) and wherein said second connection element (11, 11a, 11b, 11c) is integral with said lifting means (3).

39. Device according to claim 36, wherein said first element (9, 9a, 9b, 9c) furthermore comprises a projecting element (13) suitable for coupling with a further seat (14) with substantially conjugate profile.

40. Device according to claim 36, wherein said second element (11, 11a, 11b, 11c) presents a side aperture (40) suitable for permitting coupling/decoupling of said connection means (8).

41. Device according to claim 36, wherein said first element (9c) has a polygonal base.

42. Device according to claim 36, wherein said first element (9b) is provided with teeth (90).

43. Device according to claim 36, wherein said articulation means (4) comprise a joint with at least two degrees of freedom.

44. Device according to claim 43, wherein said joint allows said lifting means (3) to rotate with respect to a first substantially horizontal axis (15) and to translate along a second axis (16) substantially square or transverse to said first axis (15) to permit coupling and decoupling of said connection means (9, 11).

45. Device according to claim 43, wherein said joint comprises a pin (17) integral with said fixing element (2) which engages in a shaped through hole (18) made in a bracket (18a) integral with the lifting means (3).

46. Device according to claims 43, wherein said articulation means (4) comprise a pin (17) integral with said fixing element and suitable for engaging in a hole (18) made on said first connection element (9a).

47. Device according to claim 36, wherein said articulation means (4) comprise at least one guide element (19) cooperating with said lifting means to position said device in said folded and work positions.

48. Device according to claim 36, wherein said articulation means (4) furthermore comprise at least one guide element (19) cooperating with said lifting means to provide coupling and decoupling of said connection means.

49. Device according to claim 47, wherein said at least one guide element (19) cooperates with said lifting means to contribute to supporting said lifting means (3) in the rest position.

50. Device according to claim 46, wherein said at least one guide element (19) comprises a guide rod (20) suitable for rotating around a rotation axis (22) substantially parallel to the rotation axis (15) of said lifting means (3) and having one end (20b) suitable for positioning in contact with said at least one supporting element (5).

51. Device according to claim 49, wherein said at least one guide element (19) comprises at least one telescopic rod (20d) having one first end (20a) hinged to a pin (21) identifying a rotation axis (22) substantially parallel to said rotation axis (15) of said lifting means (3) and the other end connected to said supporting element (5) by means of another hinge (30).

52. Device according to claim 50, wherein the rotation axis (22) of said at least one guide element is positioned below the horizontal plane that intersects said rotation axis (15) of said lifting means (3) and in the semi-space formed by the vertical plane passing through said rotation axis (15) which is not involved in the rotation of said lifting means (3).

53. Device according to claim 36, wherein said lifting means (3) comprise a jack (6).

54. Device according to claim 53, wherein said jack (6) is of the mechanical and/or hydraulic and/or pneumatic type.

55. Device according to claim 53, wherein said mechanical jack (6) is of the screw type.

56. Device according to claim 55, wherein said lifting means (3) furthermore comprise an electric motor 25 suitable for driving said jack powered by the electrical system of said vehicle and/or by additional accumulators and/or generators.

57. Device according to claim 36, wherein said lifting means (3) are controlled by a control unit via a remote control device.

58. Device according to claim 36, wherein said device furthermore comprises elastic means (26) cooperating with said articulation means (4) during lifting and/or positioning substantially square to the ground of said lifting means (3).

59. Device according to claim 58, wherein said elastic means comprise at least one helical spring (27) having one end (28) integral with said lifting means (3) and the other end (29) integral with said guide element (19).

60. Device according to claim 36, wherein said device furthermore comprises means suitable for detecting when said device has reached the rest position and blocking said lifting means.

61. Device according to claim 36, wherein said lifting means (3) can be manually activated.

62. Device according to claim 36, wherein in said folded position said lifting axis (7) is substantially horizontal and/or parallel to the ground (S).

63. Device according to claim 36, wherein said rigid connection is obtained by exploiting the movement of said lifting means (3).

64. Device according to claim 36, wherein the movement of said lifting means from said folded position to said work position is obtained by exploiting the movement of said lifting means (3).

65. Lifting, stabilising and levelling system for a vehicle comprising a control unit (50) and at least one lifting/stabilising device (1, 100, 200) wherein said at least one lifting and stabilising device is carried out according to claim 36.

66. System according to claim 65, wherein said control unit (50) also comprises an apparatus suitable for perceiving any slanting of the vehicle in its two longitudinal and transverse axes and for cooperating with a processing unit which controls said lifting/stabilising devices to adjust said devices by raising/lowering them until obtaining levelling of said vehicle.

67. System according to claim 65, wherein said control unit (50) is furthermore provided with a control panel (51) for activation in local mode and/or of a radio receiver unit cooperating with a corresponding radio transmission unit (52), for remote activation of the system.

68. Process for lifting a vehicle by means of a lifting and/or stabilising device (1, 100, 200) comprising:
at least one fixing element (2) for anchoring said device to said vehicle;
lifting means (3) provided with an actuator (6) suitable for moving at least one supporting element (5) along a lifting axis (7) to lift said vehicle;
articulation means (4) suitable for allowing said lifting means (3) to move from at least one first folded position, in which said lifting axis (7) is not square to the ground (S), to at least one second work position in which said lifting axis (7) is in a position substantially square to the ground (S);
before lifting said vehicle said lifting means are connected rigidly to said fixing element exploiting the movement of said lifting means, by means of a male-female coupling;
wherein said coupling comprises a first connection element (9, 9a, 9b, 9c) with a truncated cone-shaped head (10) suitable for coupling with a second connection element (11, 11a, 11b, 11c) comprises a corresponding truncated cone-shaped seat (12, 12c) with substantially conjugate profile.
